(19) United States
(12) Patent Application Publication
(10) Pub. No.: US 2023/0262042 A1
(43) Pub. Date: Aug. 17, 2023

(54) METHOD FOR DEFINING AUTHENTICATION DATA OF A USER AT AN ENERGY CONVERSION DEVICE, AND ENERGY CONVERSION DEVICE

(71) Applicant: SMA Solar Technology AG, Niestetal (DE)

(72) Inventors: Dirk Schlote, Kassel (DE); Jens Klein, Göttingen (DE); Raimund Thiel, Bad Zwesten (DE); Mirko Wischer, Bad Hersfeld (DE); Ingo Hanke, Göttingen (DE)

(21) Appl. No.: 18/306,259

(22) Filed: Apr. 25, 2023

Related U.S. Application Data
(63) Continuation of application No. PCT/EP2022/059490, filed on Apr. 8, 2022.

(30) Foreign Application Priority Data
Apr. 21, 2021 (DE) 10 2021 110 140.9

(51) Int. Cl. H04L 9/40; G06F 21/31; H02J 3/38

(52) U.S. Cl. CPC H04L 63/08; G06F 21/31; H02J 3/381; H02J 2300/24

(57) ABSTRACT

A method for defining authentication data of a user at an energy conversion device connected to a grid and a source via a network connection includes receiving at the energy conversion device, via the network connection, a request from the user to newly assign authentication data, receiving at the energy conversion device desired authentication data of the user via the network connection, and storing the desired authentication data in the energy conversion device for an authentication of the user in the event of subsequent attempts to access the energy conversion device, when the energy conversion device is disconnected from the connected grid within a first predefined time window after receiving the request.

### CROSS REFERENCE TO RELATED APPLICATIONS

This application is a continuation of International Patent Application Number PCT/EP2022/059490, filed on Apr. 8, 2022, which claims priority to German Patent Application number 10 2021 110 140.9, filed on Apr. 21, 2021, and is hereby incorporated by reference in its entirety.

### FIELD

The disclosure relates to a method for defining authentication data of a user at an energy conversion device via a network connection, the energy conversion device being connected to a grid and a source. The disclosure further relates to an energy conversion device, for example, in the form of an inverter configured to carry out the method.

### BACKGROUND

User access to energy conversion devices, for example, inverters, via a network connection is a widespread function which is also often necessary for operation and maintenance. Authentication data of the user requested in the event of an access attempt are stored for this purpose in the energy conversion device for authenticating the user, for example, an owner of the device or a service technician. This can be, for example, a password with which the user can log in to the energy conversion device.

Document US 2011/0184575 A1, for example, describes how the provision of electrical power on a connection in a smart grid is made dependent on a successful authentication of the user or of the device. Furthermore, document JP 2008-108022 A describes a management system for the purpose of maintaining a device, the management system being protected against misuse, with which a service technician registers in advance, specifying a maintenance plan, and retrieves individual components of the maintenance plan at the time of the maintenance via a URL assigned, respectively, to the component of the maintenance plan.

It may now happen that the user loses or forgets the authentication data, or that other, unauthorized parties acquire knowledge of the authentication data, as a result of which the user would lose the access rights to the energy conversion device or unauthorized parties could obtain access to the energy conversion device. The need therefore exists to provide a method for the user by means of which the user can transmit new authentication data to the energy conversion device so that the authentication data are accepted for subsequent access attempts. A method of this type is intended to be simply implementable by the user, but at the same time is also intended to meet security requirements which prevent unauthorized users from being able to misuse the method in order, for example, to store their own authentication data on the energy conversion device, wherein the data can be used for subsequent access attempts, or to lock out authorized users from the energy conversion device.

### SUMMARY

The disclosure is directed to a method for defining authentication data of a user at an energy conversion device which is easy to implement but protected against misuse, and an energy conversion device configured to enable the definition of authentication data of a user with a method of this type.

In one embodiment of the disclosure, a method is disclosed for defining authentication data of a user at an energy conversion device via a network connection, wherein the energy conversion device is connected to a grid and to a source. The method comprises:
the energy conversion device receiving, via the network connection, a request from a user to newly assign authentication data;
the energy conversion device receiving desired authentication data of the user via the network connection;
storing, for example, permanently, the desired authentication data in the energy conversion device for the authentication of the user in the event of subsequent attempts to access the energy conversion device, when the energy conversion device is disconnected from the connected grid within a first predefined time window after receiving the request.

In one embodiment, the request from the user to newly assign authentication data and/or the desired authentication data can contain information relating to the identity of the user. On completion of the method, the user can log in as an authorized user on the energy conversion device at a later time by means of the stored authentication data. The authentication data can contain, for example, a password, a certificate, or a token generated by the user.

The method is, in one embodiment, carried out on a communication processor of the energy conversion device that manages the network connection of the energy conversion device. The communication processor can, in one embodiment, be supplied if required with electrical power from the grid and the source for this purpose, so that a sufficient supply of the communication processor can be ensured even while the energy conversion device is disconnected from the grid. A temporary supply of the communication processor during the disconnection from the grid and/or the source by means of an energy source integrated into the energy conversion device, for example, by means of a battery, is also conceivable.

In one embodiment, by linking the permanent storage of the desired authentication data in the energy conversion device with a disconnection of the energy conversion device from the connected grid within a predefined time window, it can be ensured that the user has to remain in the immediate vicinity of the energy conversion device when he sends the request to newly assign authentication data to the energy conversion device. It would otherwise be impossible for him to effect a disconnection of the energy conversion device from the connected grid in a targeted manner within the predefined time window. The user can send the request to newly assign authentication data via a mobile data device, for example, a smart phone or a laptop, while he is located in the immediate vicinity of the energy conversion device. He/she then disconnects the energy conversion device from the connected grid manually, for example, by actuating a disconnecting switch or by tripping a fuse.

In one embodiment, in order to ensure that a temporary power failure does not accidentally result in the success of a fraudulent request from an unauthorized user to newly assign authentication data, a reconnection of the energy conversion device to the grid within a second time window relative to the time of the disconnection of the energy device from the connected grid can additionally be requested. The second time window can be, in one embodiment, predefined for this purpose in such a way that it starts, for example, 10 seconds after the disconnection of the energy conversion device from the connected grid. The duration of the second time window can further be limited, for example, to a duration which is equal to or less than 20 seconds. In this way, randomly occurring, short-term power failures of the grid which normally last less than 10 seconds, and also longer-lasting power failures which last longer than 30 seconds do not result in a successful storage of authentication data by an unauthorized user. Since it is largely impossible to cause power failures in a targeted manner from a remote location, the power failures starting within the predefined first time window and having a duration defined by the second time window, misuse of the method in this way is by and large excluded.

However, it is also conceivable in one embodiment that just a disconnection of the energy conversion device from the connected grid is necessary in order to effect permanent storage of the desired authentication data, and that the energy conversion device can remain disconnected from the grid until the permanent storage takes place.

In one embodiment, in order to make it easier for the user to perform the disconnection of the energy conversion device from the grid or the reconnection of the energy conversion device to the grid within the first time window, the energy conversion device can signal the start and/or end of the first time window. Signaling of this type can be performed visually or audibly. The user can then manually actuate a disconnecting element, for example, a disconnecting switch or fuse, in the indicated time period. If the energy conversion device signals the start and/or end of the first time window in any event, the start and/or the end of the time window can also be chosen randomly within a predefined value range. This further hinders misuse of the method.

In one embodiment, the start and end of the second time window can similarly be indicated visually or audibly in order to make it easier for the user to choose the correct time for a reconnection of the energy conversion device to the grid.

In one embodiment, the desired authentication data can be received before the disconnection of the energy conversion device from the connected grid, for example, together with the request to newly assign authentication data. In this case, the desired authentication data are permanently stored immediately after the disconnection or reconnection of the energy conversion device from or to the grid.

In one embodiment, it can be stipulated that the desired authentication data must be received within a third predefined time window after the disconnection of the energy conversion device from the connected grid in order to achieve permanent storage of the desired authentication data in the energy conversion device. The start of the time window can be related to the time of disconnection of the energy conversion device from the grid or the time of reconnection and can coincide with one of these times or can occur a predefined time duration later. In order to further increase the security of the method against misuse in this variant, it can be defined that the third predefined time window ends 10 minutes at the latest after the disconnection of the energy conversion device from the grid.

In one embodiment, in order to prevent a further possibility for misuse of the method by an unauthorized user, it can be stipulated that the method is terminated and received desired authentication data are discarded if a communication processor of the energy conversion device involved in carrying out the method is restarted within the first time window.

In one embodiment, in order to increase security against misuse of the method, it is further possible and appropriate for the number of consecutive receive events involving requests to newly allocate authentication data to be recorded in the energy conversion device, the requests not having resulted in permanent storage of the desired authentication data in the energy conversion device, i.e. the number of unsuccessful requests, is also counted. Permanent storage of the desired authentication data in the energy conversion device is prevented permanently or for a predefined time period if the number exceeds a maximum number. This maximum number can, for example, be specified as two or three. However, in one embodiment it is recommended to block the method for a predefined time period to prevent the possibility of an authorized user being permanently blocked due to fraudulent unsuccessful attempts.

In one embodiment, in order to monitor the network connection of the energy conversion device, receive events involving requests to newly allocate authentication data can be reported by the energy conversion device via the network connection to a portal. It is also possible to report whether the respective requests have resulted in permanent storage of the desired authentication data in the energy conversion device or have remained unsuccessful. In this way, misuse attempts are quickly discovered and a suitable response to a security threat of this type can be instigated.

In one embodiment of the disclosure, an energy conversion device is configured to carry out the method described above. In one embodiment, the energy conversion device comprises an inverter, wherein the source is a direct-current source, for example, a battery or photovoltaic generator. The energy conversion device is, in one embodiment, configured to be supplied by the source during a disconnection from the grid. However, it is also conceivable to provide a dedicated energy source in the energy conversion device to supply the communication processor, the source ensuring a supply of the communication processor during a disconnection of the energy conversion device from the grid and/or from the source in accordance with the described method.

Since energy conversion devices connected to the grid typically have a sensor system which allows an active connection to the grid to be monitored anyway, no additional hardware is also normally required in order to enable the energy conversion device to carry out the method. An adaptation of the communication software which, for example, is executable on a communication processor managing a network connection of the energy conversion device suffices in many cases. This makes the method according to the disclosure attractive on cost grounds also.

In one embodiment of the disclosure, the check for disconnection from the connected grid can also be replaced or supplemented by a check to determine whether an actuation sensor of the energy conversion device has been actuated in the first predefined time window. An actuation sensor of this type can be a switch or a button of the energy conversion device. An implementation of the actuation sensor as a knocking sensor is advantageous in one embodiment, so that a knocking on the energy conversion device can be used for permanent storage of the desired authentication data. Wear of a disconnecting element for disconnecting the energy conversion device from the grid can be avoided in this way. A method for defining authentication data of a user on an energy conversion device connected to a grid and a source via a network connection correspondingly then comprises:
the energy conversion device receiving, via the network connection, a request from the user to newly assign authentication data;
the energy conversion device receiving desired authentication data of the user via the network connection;
storing, for example, permanently, the desired authentication data in the energy conversion device for the authentication of the user in the event of subsequent attempts to access the energy conversion device, when an actuation sensor, for example, a knock sensor, of the energy conversion device is actuated within a first predefined time period after receiving the request.

The further implementations which are disclosed in the description of the method according to the disclosure can similarly be used in this embodiment of the method.

### BRIEF DESCRIPTION OF THE FIGURES

The disclosure is explained in detail below with reference to figures, in which:

FIG. 1 shows a flow diagram for a first embodiment of the method according to the disclosure,

FIG. 2 shows a flow diagram for a second embodiment of the method according to the disclosure, and

FIG. 3 shows an example of a sequence of events during a performance of the method according to the disclosure.

### DETAILED DESCRIPTION

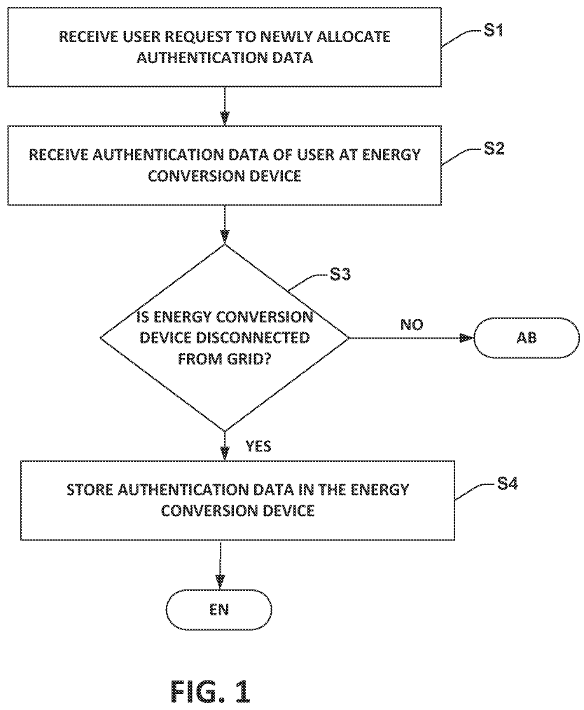

FIG. 1 shows a flow diagram for a first embodiment of the method according to the disclosure. The method begins (ST) with a first act S1 in which a request from the user to newly allocate authentication data is received on the conversion device via the network connection. In response to receiving the request, the energy conversion device can invalidate the previous authentication data of the user permanently or for a predefined time period, wherein this response can also be made dependent on whether the method has already been carried out unsuccessfully before. The response (to invalidate previous authentication data) can also be made dependent on how long ago the method was last performed successfully for this user or for users in general. However, the previous user data can also remain valid in one embodiment in order to prevent a fraudulent blocking of an authorized user.

In a subsequent second act S2, the energy conversion device receives desired authentication data of the user via the network connection. The first act S1 and the second act S2 can be performed successively in separate communication procedures or jointly in a single communication procedure.

In a third act S3, a check is then carried out to determine whether the energy conversion device is disconnected from the connected grid within a first predefined time window. Optionally, an additional check can also be carried out in the third act S3 to determine whether a reconnection to the grid also takes place within the first time window. In one embodiment, the first time window starts immediately or a predefined time duration after the request has been received. A second time window within the first time window defines a permitted duration of the disconnection of the energy conversion device from the connected grid so that, in one embodiment, the duration is a minimum of 10 seconds and a maximum of 30 seconds. The start of the first time window and optionally the end of the second time window also can be indicated by the energy conversion device, for example, in audible form or in visual form. This makes it easier for a user located at the energy conversion device to manually perform a disconnection of the energy conversion device from the grid within the first time window in order to verify the request to newly allocate authentication data.

When the check in the third act S3 is concluded with a positive result (YES at S3), i.e. a disconnection of the energy conversion device from the connected grid and possibly also a reconnection to the grid have taken place within the first time window, the desired authentication data are permanently stored in the energy conversion device in a fourth act S4 instead of the previous authentication data of the user in order to authenticate the user during subsequent attempts to access the energy conversion device. The method is then ended (EN).

In the event of a negative result of the check in the third act S3 (NO at S3), the method is terminated (AB).

In one embodiment, the successful ending and/or the termination of the method can be indicated in a suitable manner visually or audibly by the energy conversion device.

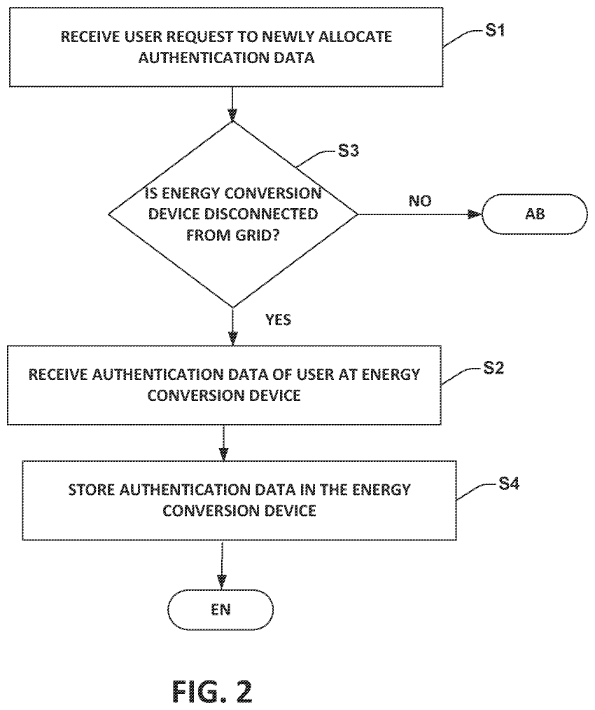

FIG. 2 shows a flow diagram for a second embodiment of the method according to the disclosure. The second embodiment differs from the first embodiment of the method according to the disclosure in that the desired authentication data of the user are received on the energy conversion device according to the second act S2 after a successful performance of the check according to the third act S3. A third time window which can start immediately after the successful conclusion of the check in act S3 is provided for receiving the desired authentication data. The duration of the third time window is dimensioned in such a way that an authorized user can easily transmit desired authentication data to the energy conversion device within the time window. The time window can last, for example, between 1 and 10 minutes in one embodiment.

The conclusion of the check in act S3 with a positive result therefore switches the energy conversion device temporarily to a state in which it can receive the desired authentication data and permanently store them in the energy conversion device in order to use them for future access attempts by the user. In a fourth act S4, received valid authentication data are stored, for example, permanently, in the energy conversion device and the method is ended (EN). If no valid authentication data are received within the third time window, the method is ended (EN) by continuing to use the previous authentication data.

If the check at act S3 ends with a negative result (NO at S3), any received desired authentication data of the user are ignored and the method is terminated (AB).

Along with the signaling of the start and/or end of the first time window described in connection with the first embodiment, the energy conversion device can additionally also signal the start and/or end of the second time window, and also the start and/or end of the third time window visually or audibly in the second embodiment. In addition, the successful conclusion of the method with the storage, for example, permanent storage of the desired authentication data and/or the termination of the method without permanent storage can be indicated visually or audibly. This makes it easier for the user to send the desired authentication data in a timely manner to the energy conversion device via the network connection and to receive an acknowledgement of the successful conclusion of the new allocation of the authentication data.

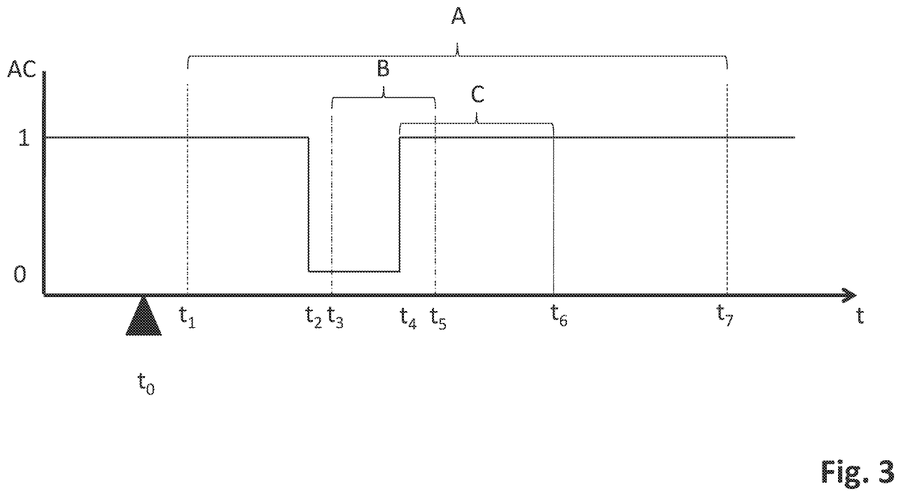

The temporal sequence of events for a successful performance of the method according to one embodiment of the disclosure is shown more precisely in FIG. 3, wherein the time is plotted on the x-axis and the state of the connection of the energy conversion device to the grid is plotted on the y-axis. A connection of the energy conversion device to the grid is symbolized by the value 1, a disconnection from the grid by the value 0. At time t₀, the energy conversion device receives a request from the user to newly allocate authentication data. As a result, a first time window A extending from time t₁ to time t₇ is defined, within which a disconnection and possibly also a reconnection of the energy conversion device from/to the grid must take place in order to effect a new allocation of the authentication data. Time t₁ occurs a predefined time duration after time t₀, for example 10 seconds thereafter, or can also be identical to time to. Time t₇ can then occur, for example, 20 minutes after time t₀ (or after time t₁).

In the case shown, the disconnection from the grid actually takes place at time t₂. As a result, a second time window B is in turn defined, starting at time t₀ and ending at time t₅, within which a reconnection of the energy conversion device to the grid must take place in order to effect a new allocation of the authentication data. Time to occurs a predefined time duration after time t₂, for example, 10 seconds thereafter. Time t₇ can then occur, for example, 30 seconds after time t₂ (or after time t₃).

In the case shown, the reconnection to the grid actually takes place at time t₄. As a result, a third time window C is in turn defined, starting at time t₄ and ending at time t₆, within which desired authentication data of the user must be received by the energy conversion device in order to effect a new allocation of the authentication data. Time t₆ can then occur, for example, 2 minutes after time t₄ (or after time t₂).

If one of the required events, i.e. the disconnection of the energy conversion device from the grid, the reconnection to the grid and the reception of the desired authentication data, does not take place within the corresponding time windows A, B, C, the desired authentication data are not permanently stored in the energy conversion device for authentication of the user in the event of subsequent access attempts.

In one embodiment of the method, the desired authentication data do not need to be received within time window C, since the authentication data have in fact already been received by the energy conversion device before the energy conversion device is disconnected from the connected grid.

The start and end of time windows A and B can be indicated by the energy conversion device in visual or audible form, preferably distinguishable from one another. The completed storage of the desired authentication data can also be indicated in audible or visual form.

The method according to the disclosure can be supplemented by further measures known to a person skilled in the art for increasing security against misuse, for example by an encrypted transmission of data between the user and the energy conversion device, a 2-factor authentication, or similar measures.

What is claimed is:

1. A method for defining authentication data of a user at an energy conversion device connected to a grid and a source via a network connection, comprising:
receiving at the energy conversion device, via the network connection, a request from the user to newly assign authentication data;
receiving at the energy conversion device desired authentication data of the user via the network connection;
storing the desired authentication data in the energy conversion device for an authentication of the user in an event of subsequent attempts to access the energy conversion device, when the energy conversion device is disconnected from the grid within a first time window after receiving the request.

2. The method as claimed in claim 1, wherein the desired authentication data is received before the disconnection of the energy conversion device from the grid in order to achieve storage of the desired authentication data in the energy conversion device.

3. The method as claimed in claim 1, wherein, within the first time window, the energy conversion device is reconnected to the grid within a second time window relative to a time of the disconnection of the energy conversion device from the grid in order to effect storage of the desired authentication data in the energy conversion device.

4. The method as claimed in claim 3, wherein the second time window starts no sooner than 10 seconds after the disconnection of the energy conversion device from the grid.

5. The method as claimed in claim 3, wherein the second time window has a duration which is less than or equal to 20 seconds.

6. The method as claimed in claim 1, wherein the desired authentication data is received within a third time window after the disconnection of the energy conversion device from the connected grid in order to achieve storage of the desired authentication data in the energy conversion device.

7. The method as claimed in claim 6, wherein the third time window ends after a predefined time duration after the disconnection of the energy conversion device from the grid.

8. The method as claimed in claim 3, wherein the first time window ends no more than 20 minutes after the request has been received on the energy conversion device.

9. The method as claimed in claim 3, wherein the energy conversion device signals a start and an end of the first time window and/or of the second time window.

10. The method as claimed in claim 1, further comprising terminating the method and discarding received desired authentication data when a communication processor of the energy conversion device involved in carrying out the method is restarted.

11. The method as claimed in claim 1, wherein a number of consecutive receive events involving requests is determined in the energy conversion device, said requests not having resulted in permanent storage of the desired authentication data in the energy conversion device, and preventing permanent storage of desired authentication data in the energy conversion device or storage for a predefined time period if the number exceeds a maximum number.

12. The method as claimed in claim 1, further comprising determining receive events involving requests to newly allocate authentication data, said requests not having resulted in permanent storage of the desired authentication data in the energy conversion device, and reporting the receive events by the energy conversion device via the network connection to a portal.

13. An energy conversion device configured to carry out the method as claimed in claim 1.

14. The energy conversion device as claimed in claim 13, wherein the energy conversion device comprises an inverter, and wherein the source comprises a battery or photovoltaic generator direct-current source.

15. The energy conversion device as claimed in claim 14, wherein the inverter is configured to be supplied by the source during a disconnection from the grid.
